(19) United States
(12) Patent Application Publication
(10) Pub. No.: US 2010/0127034 A1
(43) Pub. Date: May 27, 2010

(54) Optical Fiber Cleave Tool

(75) Inventors: Kevin Gerard Bouchard, Bristol, CT (US); David Lui, Glastonbury, CT (US); Mark Thomas Zmurko, Winsted, CT (US)

Correspondence Address: OFS Fltel, LLC;(FORMERLY FURUKAWA ELECTRIC NORTH AMERICA, INC.), 2000 NORTHEAST EXPRESSWAY, NORCROSS, GA, 30071, US

(73) Assignee: FURUKAWA ELECTRIC NORTH AMERICA, INC., Norcross, GA (US)

(21) Appl. No.: 12/597,564

(22) PCT Filed: Apr. 25, 2008
(86) PCT No.: PCT/US08/61570

§ 371 Date: Oct. 26, 2009

Related U.S. Application Data
(60) Provisional application No. 60/914,416, filed on Apr. 27, 2007.

(51) Int. Cl. G02B 6/25; B65H 35/10

(52) U.S. Cl. 225/2; 225/96; 225/100

(57) ABSTRACT

An apparatus and method for cleaving an optical fiber. The method includes supporting a connector in a fixed axial position along an axis of an optical fiber extending from an end of the connector, and placing an axial tension along the axis of the optical fiber. A fiber engaging member is moved along an arcuate path such that a sharpened blade tip of the fiber engaging member cuts across a cut location of the optical fiber. The axial tension induces crack propagation through the thickness of the optical fiber at the cut location.

### CROSS REFERENCE TO RELATED APPLICATIONS

This application claims the benefit of provisional application Ser. No. 60/914,416 filed Apr. 27, 2007, the entire contents of which are incorporated herein by reference.

### BACKGROUND OF THE INVENTION

1. Field of the Invention

The present invention relates generally to cleaving optical fibers, and more specifically to a method and apparatus for cleaving an optical fiber with a cutting motion.

2. Discussion of the Background

For efficient light transmission from a terminal end surface (end face) of an optical fiber, the end face should be flat, perpendicular to the axis of the fiber, and provided with a smooth finish to provide the maximum optical transmission area on the fiber end face and to minimize light losses resulting from reflection and refraction of the light.

Most commercially available cleave tools for optical fibers perform well only if the glass optical fiber has had it's polymer coating (also known as “buffer” in some cases) removed. Most commercially available cleave tools for optical fiber utilize a method of initiating a cleave propagation point by means of a scribing motion or a direct force normal to the longitudinal axis of the optical fiber. For example, FIG. 7 shows a conventional cleaving method using a scribing motion. As seen in this figure, a glass optical fiber 810 (having its coating removed) is held, and a blade 820 is moved in the direction of the arrow in FIG. 7 such that the blade cutting, surface 822 is made to contact the fiber 810 at a scribe point 812. FIG. 8 shows a conventional cleaving method using a direct force normal to a longitudinal axis of the optical fiber. As seen in FIG. 8, the glass optical fiber 910 having its coating removed is held and a cleaving blade 930 is moved in a linear direction of the arrow in FIG. 8 to provide a direct force normal to the fiber 910. The cleaving blade comes in contact with the fiber 910, and the cutting surface 932 of the cleaving blade 930 initiates a crack that propagates through the optical fiber 910.

FIG. 9 shows a conventional method for cleaving a coated optical fiber without the need to remove the coating. As seen in this figure, the optical fiber 1010 includes a glass optical core 1012 and a coating 1014 such as a polymer coating. The optical fiber 1010 is held while a cleaving tool 1020 is moved in a direction of the arrow in FIG. 9 to provide a direct force normal to a longitudinal axis of the fiber 1010. This force causes the cleaving blade 1022 to penetrate the coating and reach the glass surface to initiate cleaving of the glass. For example, U.S. Pat. No. 5,108,021 shows a method for cleaving an optical fiber wherein the cleaving blade penetrates the coating until it reaches the glass surface so that it can initiate the cleave in the glass. The entire content of U.S. Pat. No. 5,108,021 is incorporated herein by reference. A cleave tool of this type (for example DT03130-03 provided by OFS Fitel, LLC, “OFS”, which is a wholly owned subsidiary of Furukawa Electric North America) has been used for cleaving optical fibers such as the CF01493-10 fiber (also provided by OFS). The CF01493-10 fiber includes a medium NA HCS® polymer coated silica optical fiber having mechanical properties, such as a relatively hard polymer coating, which allow the cleave tool such as that shown in FIG. 9 to provide a direct force sufficient to penetrate the HCS® coating and reach the glass optical fiber surface to successfully initiate the cleave in the glass.

The present inventors have recognized, however, that there are occasions when the glass optical fiber has a polymer coating which obstructs the cleave blade from reaching the glass surface in a timely manner; if at all. Such polymer coatings may, for example, have characteristics (i.e. harder, softer, thicker wall, etc.) which cause the direct force normal to longitudinal blade motion to not perform well. For example, new high bandwidth optical fibers such as the F14404 fiber manufactured by OFS include a non-optical polymer coating that behaves differently than the medium NA HCS® optical fiber when a force is applied normal to the fiber axis as shown in FIG. 9.

### SUMMARY OF THE INVENTION

Accordingly, one object of the present invention is to address the above and/or other issues relating to cleaving optical fibers.

One embodiment of the invention includes a method for cleaving an optical fiber, the method including supporting a connector in a fixed axial position along an axis of an optical fiber extending from an end of the connector, and placing an axial tension along the axis of the optical fiber. A fiber engaging member is moved along an arcuate path such that a sharpened blade tip of the fiber engaging member cuts across a cut location of the optical fiber, whereby the axial tension induces crack propagation through the thickness of the optical fiber at the cut location.

In another embodiment, a cleaving tool for cleaving an optical fiber includes a cleaving assembly configured to support a connector in a fixed axial position along an axis of an optical fiber extending from an end of the connector, the cleaving assembly including a fiber engaging member having a sharpened blade tip. A fiber tensioning assembly is configured to place an axial tension along the axis of the optical fiber. The fiber tensioning assembly including an actuator member configured to actuate the cleaving assembly and the fiber tensioning assembly such that the fiber engaging member is moved along an arcuate path and the sharpened blade tip cuts across a cut location of the optical fiber, whereby the axial tension induces crack propagation through the thickness of the fiber at the cut location.

In still another embodiment, a cleaving tool for cleaving an optical fiber includes a cleaving assembly configured to support a connector in a fixed axial position along an axis of an optical fiber extending from an end of the connector, the cleaving assembly including a fiber engaging member having a sharpened blade tip. Also included is a fiber tensioning assembly configured to place an axial tension along the axis of the optical fiber, the fiber tensioning assembly including an actuator member configured to actuate the cleaving assembly and the fiber tensioning assembly. Means are provided for moving the fiber engaging member along an arcuate path such that the sharpened blade tip cuts across a cut location of the optical fiber, whereby the axial tension induces crack propagation through the thickness of the fiber at the cut location.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 shows a perspective view of a cleaving tool in accordance with an embodiment of the present invention;

FIG. 2 shows details of the cleaving assembly 200 in accordance with the embodiment of the invention;

FIGS. 3A and 3B show movement of a fiber engaging member relative to an optical fiber in accordance with an embodiment of the invention;

FIGS. 4A, 4B and 4C show progressive stages along the radial movement of a blade tip in accordance with an embodiment of the invention;

FIG. 5 shows a cleaving assembly having an adjustable fiber engaging member in accordance with one embodiment of the invention;

FIG. 6 shows a fiber engaging member according to another embodiment of the invention;

FIG. 7 shows a conventional cleaving method using a scribing motion to scribe an optical fiber having a coating removed therefrom;

FIG. 8 shows a conventional cleaving method using a direct force normal to a longitudinal axis of the optical fiber having a coating removed therefrom; and

FIG. 9 shows a conventional method and device for cleaving a polymer coated optical fiber without the need to remove the coating.

### DESCRIPTION OF THE PREFERRED EMBODIMENTS

As discussed above, conventional methods of cleaving an optical fiber either require removal of a polymer coating from the optical fiber before cleaving the optical fiber, or are unsuitable for some polymer coated optical fibers. Embodiments of the present invention provide different blade motions compared to the direct three normal to the longitudinal axis motion, which essentially pushes the blade through the polymer coating until the sharp edge of the blade reaches the glass and initiates a cleave in the glass. Specifically, embodiments of the invention provide a cut action through the polymer coating to allow the blade to reach the glass surface more quickly and more effectively. As used herein, the term “cut” refers to providing relative movement of an optical fiber substantially along a surface of the blade. The relative movement may be provided by moving the blade, or the fiber, or both the blade and the fiber.

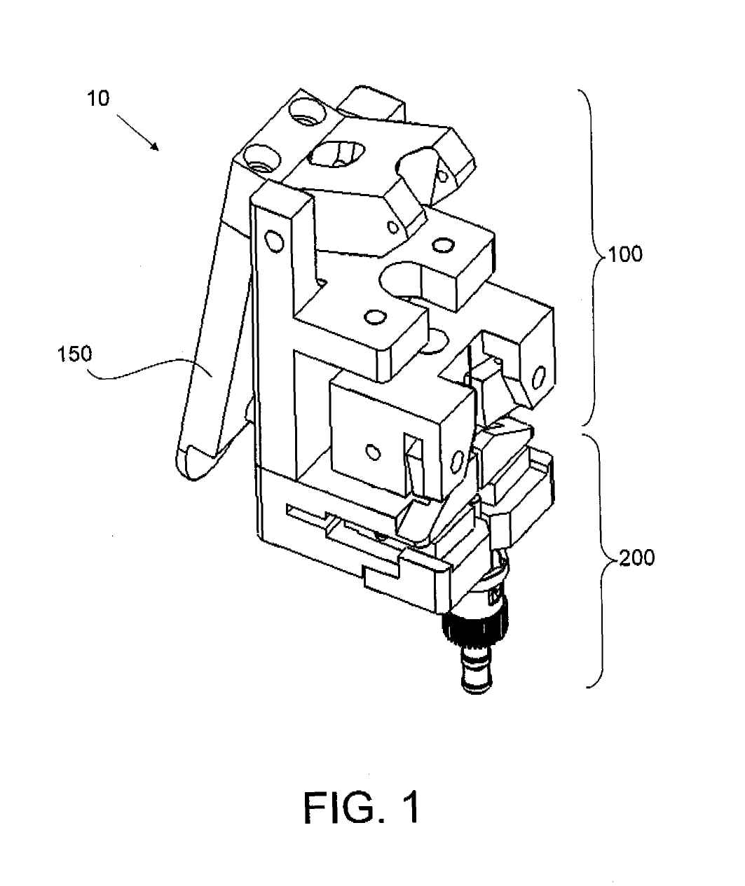

FIG. 1 shows a perspective view of a cleaving tool in accordance with an embodiment of the present invention. As seen in this figure, the cleaving tool 10 includes a fiber tensioning assembly 100 and a cleaving assembly 200. The fiber tensioning assembly 100 includes an actuator mechanism 150 for activating the fiber tensioning assembly, and for activating the cleaving assembly 200 to cleave an optical fiber, as will be further discussed below. The fiber tensioning assembly 100 includes a tensioning mechanism (not shown) for tensioning an optical fiber to be cleaved. The tensioning mechanism places a fiber under an axial tension to the fiber prior to cleaving. The amount of tension placed on the fiber is preferably adjustable. For small fibers, a small amount of tension is provided to prevent severing of the fiber in an undesirable location due to high tensile stress. For larger fibers, a larger tension is provided to the fiber prior to cleaving. The amount of tension provided on the fiber can depend on a variety of factors, including size of the optical fiber. For example, with a fiber having a glass diameter of 200 μm such as the F14404 OFS fiber noted above, the tension is preferably in the range of 0.6-0.8 lbf. (pound-force). However, other tension ranges may be used based on characteristics and application of the fiber. Tensioning mechanisms are known in the art and shown, for example, in U.S. Pat. No. 5,108,021, which is incorporated herein by reference.

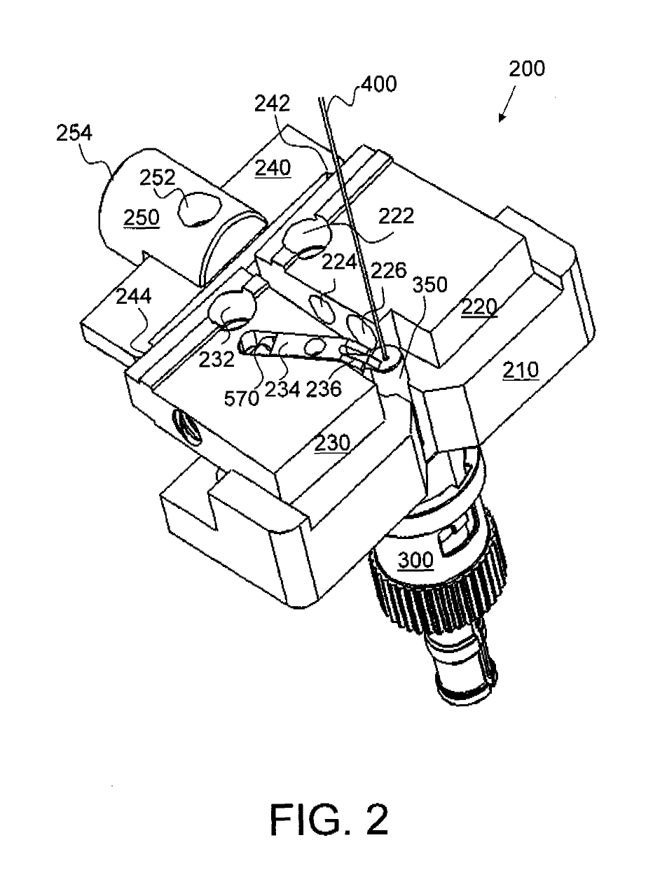

FIG. 2 shows details of the cleaving assembly 200 in accordance with an embodiment of the invention. In FIG. 2, the fiber tensioning assembly 100 is removed to reveal portions of the cleaving assembly 200. As seen in FIG. 2, a connector 300 is installed on an optical fiber 400 and is held against length wise movement by an interchangeable connector positioning plate 210 of the cleaving assembly 200. As used herein, the term “optical fiber” refers to any known type of optical fiber having a light guiding core of glass, fused silica or other material capable of transmitting a light signal. The core typically has a cladding with a material having a lower index of refraction than the light-guiding core, thereby enabling non-parallel light rays to be reflected at the core/cladding interface and propagate through the length of the core. One example optical fiber that may be cleaved in accordance with embodiments of the present invention is the F14404 fiber, manufactured by OFS and having a 62.5 μm glass core, a 200 μm glass clad and a 230 μm non-optical HCS® coating.

An aperture is formed in the plate 210 to receive the body of the connector 300, e.g., the ferrule 350, and the connector positioning plate 210 and aperture cooperate to hold the connector 300 and fiber 400 in a fixed axial extending position. Precision optical fiber connectors are used to effect alignment and abutting engagement of an optical fiber end face with a subsequent optical fiber or fiber optic device. As used herein, the term “optical fiber connector” is intended to refer to a terminal end connection for installation on the end of an optical fiber, typically comprising a ferrule mounted on the fiber against length wise movement and a fastening member to effect aligned connection of the ferrule and included fiber to an optical component or subsequent connector. Connectors are available having ferrules and fastening members of various sizes and shapes depending on the intended use of the connector. The terminal end of the ferrule aligned with the fiber end face is considered to be the “connector end.” Example connector components that may be used in accordance with embodiments of the present invention are the Straight Tip (ST) BP05062-10 sub-assy and BP00147-01 crimp ring, and the Sub-Miniature A (SMA) BP05059-10 sub-assy and BP00147-01 crimp ring, both known to those skilled in the art of optical connectors.

In accordance with embodiments of the invention, the connector is held and a fiber extending therefrom is tensioned adjacent to a fiber engaging member which scribes the fiber to initiate cleaving of the optical fiber substantially flush with the connector end. The resultant fiber end face is substantially perpendicular to the axis of the fiber, and preferably has a finish that does not require subsequent treatment to provide the desired smooth end face. In the embodiment of FIG. 2, the cleaving assembly includes a pair of levers 220, 230 supported for pivotal movement on a pair of pivot points shown by pivot holes 222, 232. The pivot holes 222 and 232 are configured to receive pivot pins (not shown), about which the levers 220 and 230 can pivot respectively. The lever 230 is suitably configured to support a fiber engaging member 234 for engagement with the fiber 400 adjacent to the end of the connector 300. In one embodiment, each lever 220, 230 may slightly move in an axial direction on pivot pins provided within the pivot holes 222, 232 to adjust in response to variations in the length of the ferrule 350. Further, while FIG. 2 shows both levers provided with pivot holes it is not necessary for both levers to pivot. For example, in one embodiment, the lever 220 airy be held in a fixed position while the lever 230 pivots to move relative to the lever 220.

The fiber engaging member 234 includes a sharpened blade tip 236, which is sufficiently ship to scribe an optical fiber. As used herein, the term “scribe” refers to a score or scratch in the surface of a glass clad optical fiber, or a cut through a polymer cladding mid score or scratch in the fiber core surface, wherein crack propagation is induced at the scratch or score location through the thickness of a fiber under axial tension.

In the embodiment of FIG. 2, the levers 220, 230 are engaged by lifting tabs 242, 244 formed on a floating swivel plate 240. The swivel plate 240 is also mounted for pivotal movement to a plunger 250 by a dowel (not shown), for example, that can be received in hole 252. The cleaving assembly 200 is activated by applying a force to the bottom surface 254 of the plunger 250, which force is transferred by the swivel plate tabs 242, 244 to the levers 220, 230 for pivoting the levers about the pivot holes 222, 232. The unique floating arrangement of the swivel plate 240 on the plunger 250 in FIG. 2 forms a compensating linkage which ensures that the force exerted on the plunger bottom surface 254 is equally divided between the levers 220, 230. Therefore, during activation of the cleaving mechanism 200, the levers 220, 230 move in substantially equal and opposite directions toward the fiber. This floating arrangement allows the cleaving mechanism to work, equally as well over a wide range of fiber diameters. In one embodiment, fibers having a diameter in the range of 200 μm to 600 μm cleaved successfully. However, the cleaving method and apparatus of the present invention may be used for fibers smaller than 200 μm and larger than 600 μm in diameter. For example, fibers having a diameter in the range of 100 μm to 1050 μm may be cleaved according to the cleaving method and apparatus of the present invention. Further, as noted above, movement of both levers is not necessary for embodiments of the invention.

Aligned recesses 224 may be formed in the levers 220, 230 (shown only in the lever 220) for receiving a return spring (not shown), which opposes the force of the plunger 250, thereby separating the levers 220, 230 when no force is exerted on the plunger 250. Additionally, an aperture 226 is formed in lever 220 for receiving a set screw (not shown), which is positioned between the levers to contact the other lever 230 during activation of the cleaving assembly to limit the travel range of the blade tip 236, as will be further described below. Blade adjustment screw 570 provides for adjusting the position of the fiber engaging member 234 and blade tip 236, as will also be described below.

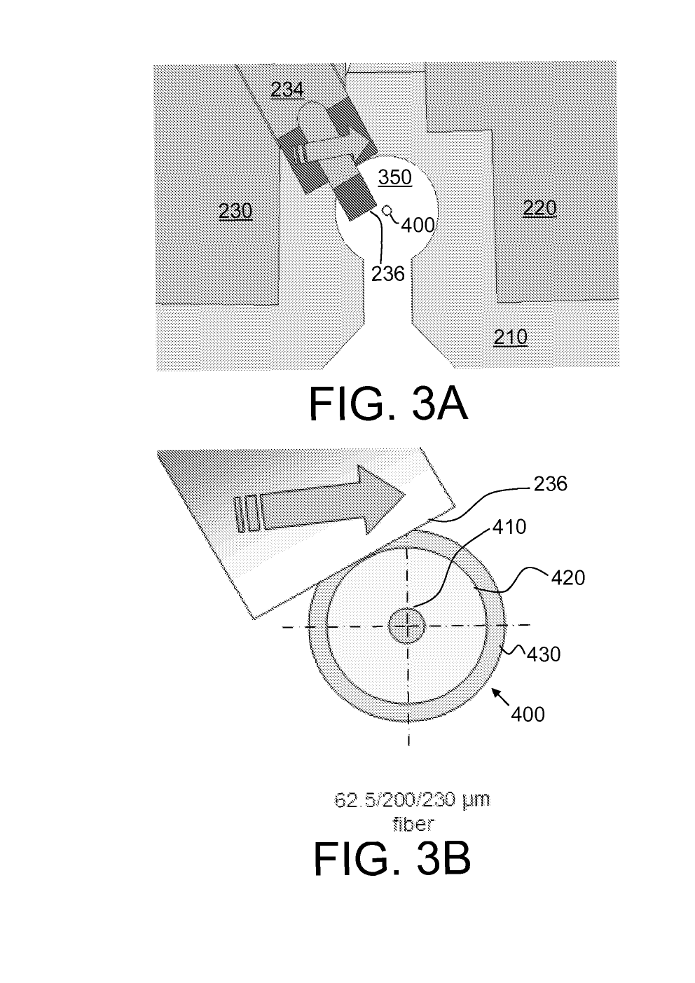

Operation of the cleaving tool 10 is described with respect to FIGS. 1-2 and 3A-3B. The cleaving tool 10 is gripped by a user preferably on a handle (not shown) with the operator's thumb free. Connector 300 is carefully inserted into the plate positioning connector 210 of the cleaving assembly 100 until it bottoms out, and the length of fiber 400 extending from the end of the connector 300 is positioned within the fiber tensioning assembly 100. The operator then presses on the actuator mechanism 150 with his/her thumb, activating the tensioning assembly 200. Continued movement of the actuator mechanism 150 will cause a force on the bottom surface 254 of the plunger 250 of the cleaving assembly 200. The force is substantially equally divided between the levers 220, 230 by the pivot plate 240, and the levers 220, 230 pivot about the pivot holes 222, 232. This causes the fiber engaging 234 and the blade tip 236 to move along a substantially arcuate path represented by the arrow in FIG. 3A, and in contact with the fiber 400 approximately flush with the end of the connector 300. Such arcuate path may also be provided by pivoting only the lever 220, for example.

FIG. 38 shows details of the fiber 400 in relation to the blade tip 236. As seen in this figure, the fiber 400 includes an optical glass core 410 and a glass cladding 420 surrounding the core 410. A polymer coating 430 further surrounds the glass cladding 420. An example optical fiber having a structure as shown in FIG. 3B is the F14404 fiber manufactured by OFS. When the blade tip 236 moves along the substantially arcuate path as represented by the arrow in FIG. 3B, the blade tip 236 penetrates the polymer coating 430 and scribes the cladding 420 of the optical fiber 400 at a scribe location. This action induces crack propagation through the cladding 420 and core 410 of the optical fiber 400 at the scribe location due to the axial tension on the fiber 400. As noted above, a set screw (not shown) limits the arcuate travel range of the blade tip 236, which is selected to ensure effective crack propagation without damaging the fiber or unnecessarily wearing the blade tip 236. Upon release of the activation mechanism 150, a spring (not shown) forces the actuator mechanism 150 back into its original position shown in FIG. 2, and a return spring forces the levers 220, 230 (or only 220, for example) to pivotally return to their original separation position shown in FIG. 2.

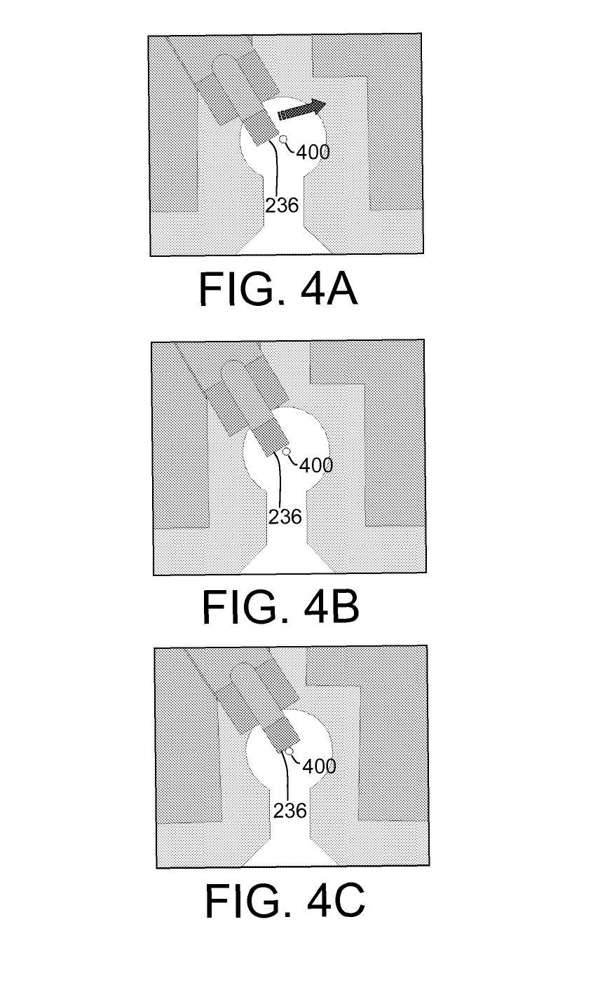

FIGS. 4A, 48 and 4C show progressive stages along the arcuate movement of a blade tip in accordance with an embodiment of the invention. As seen in FIG. 4A, the blade tip 236 approaches the fiber 400 in a direction shown by the arrow in this figure. As seen in FIG. 4B, the position of the blade tip 236 is set such that a leading edge of the blade tip 236 (the corner of the fiber engaging member 234 that first approaches the fiber) does not contact the fiber 400. Specifically, the movement path of the fiber engaging member 234 is set, for example by position of the pivot hole 232 in the lever 230 and the blade adjustment screw 570 such that only the blade tip 236 contacts the fiber 400. Further movement of the blade tip along its arc brings the blade tip 236 in contact with the fiber 400 as shown in FIG. 4C to cut a polymer coating and initiate cleaving of the optical fiber 400. A set screw, as noted above, can be used to limit the travel range of the fiber engaging member 234 and blade tip 236. In a preferred embodiment the set screw will prevent the trailing edge of the fiber engaging member 234 (the corner of the fiber engaging member 234 that first approaches the fiber last) will not pass the optical fiber.

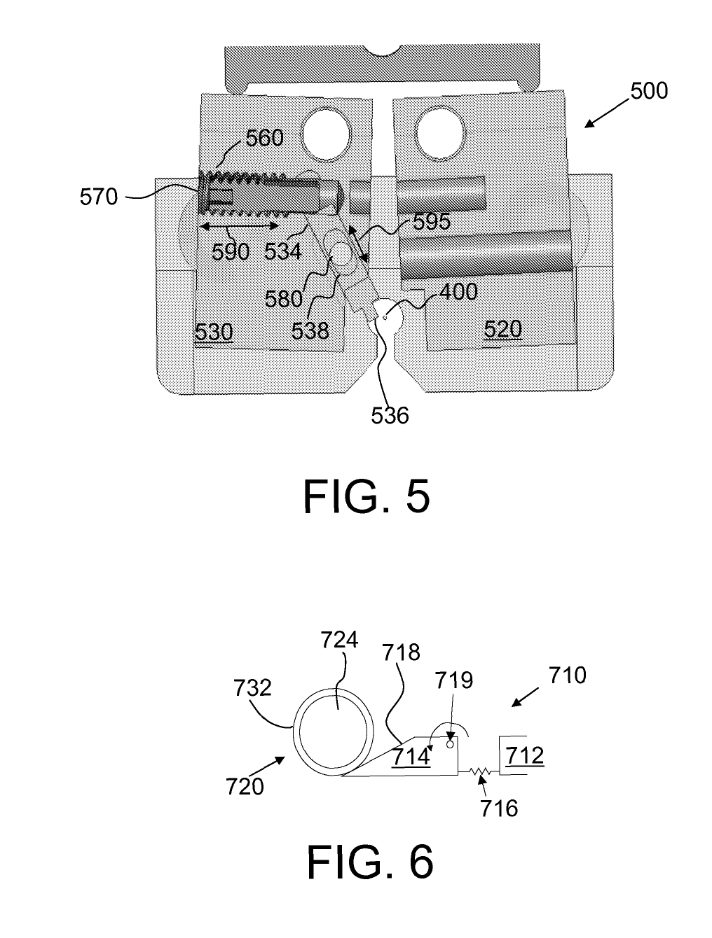

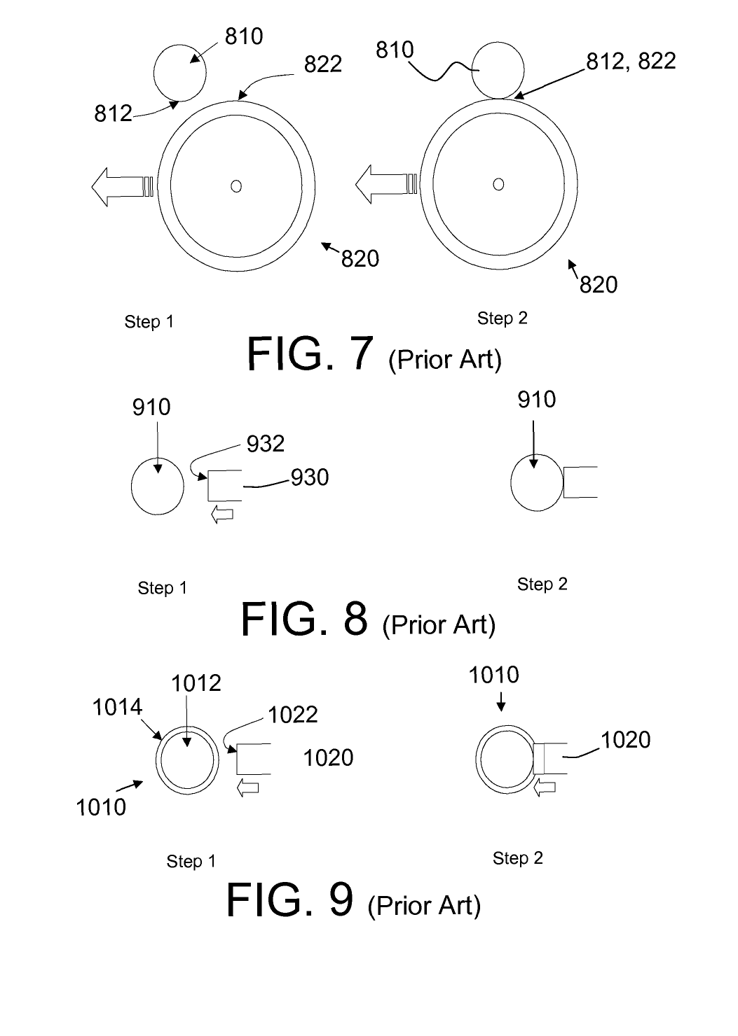

FIG. 5 shows a cleaving assembly having an adjustable fiber engaging member in accordance with one embodiment of the invention. As seen in this figure, the cleaving mechanism 500 includes similar components to those described in FIG. 2, the description of which is not repeated. The lever 530 includes a threaded bore 560 for receiving a blade adjusting screw 570 therein, and a pin screw hole 580 for receiving screw that fixes fiber engaging member 534 to the lever 530. Rotation of the blade adjusting screw 570 moves the blade adjusting screw along the arrow 590. The fiber engaging member 534 includes a slot 538, which allows the fiber engaging member and the blade tip 536 to move along arrow 595. An end of the blade adjusting screw 570 engages an end of the movable fiber engaging member 534 such that rotation of the blade adjusting set screw will move the blade tip 536 in relation to the fiber 400. Thus, the blade tip 536 can be adjusted to achieve the movement path shown in FIGS. 4A-4C, for example.

According to one method of adjusting the blade tip 536, a connector is inserted into the cleaver tool such as the cleaver tool of FIG. 1, with the fiber protruding from the ferrule. The fiber engaging member 534 is initially set to its farthest position from the fiber, and the operator activates the actuator member and observes motion of the blade tip 236, which should swing past the fiber without contacting it. The blade adjustment screw 570 is used to push the fiber engaging member 534 and blade tip 236 toward to fiber, and the user repeats activation of the actuator member until the blade tip 236 cleaves the fiber. Preferably, the fiber engaging member 534 is positioned such that blade tip 236 comes in contact with the optical fiber glass core at a center of the blade cutting surface. The screw (provided in hole 580) fixing the fiber engaging member 534 to the lever 530 must be loosened prior to adjustment, and must be tightened again to lock the fiber engaging member 534 and blade tip 236.

Thus, according to the embodiments of FIGS. 1-5 of the present invention, the outer coating of the optical fiber is penetrated and the glass optical fiber is scribed by the blade tip cutting across the optical fiber. The present inventors have recognized that this movement of the blade can provide effective and efficient cleaving of a wide range of optical fiber types without the need to remove a coating of the fiber. For example, this cutting motion is more effective in cleaving the F14404 fiber manufactured by OFS, than conventional cleaving tools that provide a force normal to an axis of the fiber.

As will be appreciated by one skilled in the art, in the embodiments described above, as the blade tip cuts across the fiber a greater force is applied by the blade tip to the fiber. The inventors recognized that this may impede the cutting action and/or damage the optical fiber during the cleaving operation. To provide minimum force to keep the coating from pushing the blade around a pivot point, a spring may be utilized. FIG. 6 shows a fiber engaging member according to another embodiment of the invention. The fiber engaging member 710 includes a first portion 712 coupled to a second portion 714 by a spring 716. The second portion 714 of the fiber engaging member 710 includes a tapered blade tip 718 and a pivot point 719 such that the blade introduces an arcuate motion when cleaving the fiber. When the blade tip 718 makes contact with the fiber 720, the blade tip 718 first cuts the polymer coating 722 and then scribes the glass optical core 724 to initiate cleaving of the fiber 720. The spring 716 biases the second portion 714 of the blade tip 718 to control a contact force with the fiber 720 as the second portion 714 rotates about the pivot point 719 to provide a compound motion of the blade. Controlling the contact force of the blade against the fiber can provide better optical coupling characteristics from the cleaved fiber, and may further minimize the precision necessary from adjusting the blade tip. For example, providing the compound motion of the blade can enhance the cutting action of the blade to facilitate the blade cutting through the coating 722 and reaching the glass core 724.

Obviously, numerous modifications and variations of the present invention are possible in light of the above teachings. It is therefore to be understood that within the scope of the appended claims the invention may be practiced otherwise than as specifically described herein. For example, the invention is illustrated as being used with a fiber having a connector installed intermediate its length; however, the invention will work equally as well with a fiber not having a connector installed which is directly held against length wise movement by the positioning plate.

1. A method for cleaving an optical fiber, comprising:
supporting a connector in a fixed axial position along an axis of an optical fiber extending from an end of the connector;
placing an axial tension along the axis of the optical fiber; and
moving a fiber engaging member along an arcuate path such that a sharpened blade tip of the fiber engaging member cuts across a cut location of the optical fiber by relative movement between the blade tip and the fiber, whereby said axial tension induces crack propagation through the thickness of the optical fiber at the cut location.

2. The method of claim 1, wherein said placing an axial tension comprises placing a predetermined axial tension along the axis of the optical fiber based on a characteristic of the optical fiber.

3. The method of claim 2, wherein said placing an axial tension comprises placing an axial tension of 0.6-0.8 pound-force along the axis of the optical fiber.

4. The method of claim 1, wherein said moving comprises providing an offset axis of rotation for the fiber engaging member such that only the sharpened blade tip of the fiber engaging member cuts across the optical fiber.

5. The method of claim 1, wherein said moving comprises moving a fiber engaging member having a tapered blade tip substantially along the arcuate path such that the tapered blade tip cuts across the optical fiber.

6. The method of claim 5, further comprising controlling a contact force applied by the tapered blade tip to the optical fiber as the tapered blade tip cuts across the optical fiber.

7. The method of claim 1, further comprising limiting a moving distance of the fiber engaging member using an adjustable set screw.

8. The method of claim 1, further comprising adjusting a position of the fiber engaging member using a blade adjusting screw.

9. A cleaving tool for cleaving an optical fiber, comprising:
a cleaving assembly configured to support a connector in a fixed axial position along an axis of an optical fiber extending from an end of the connector, the cleaving assembly including a fiber engaging member having a sharpened blade tip; and
a fiber tensioning assembly configured to place an axial tension along the axis of the optical fiber, the fiber tensioning assembly including an actuator member configured to actuate the cleaving assembly and the fiber tensioning assembly such that the fiber engaging member is moved along an arcuate path and the sharpened blade tip cuts across a cut location of the optical fiber by relative movement between the blade tip and the fiber, whereby said axial tension induces crack propagation through the thickness of the fiber at the cut location.

10. The cleaving tool of claim 9, wherein said fiber engaging member is an elongated member having an axis of rotation such that the sharpened blade tip moves along the arcuate path to cut across the optical fiber when the actuator member is actuated by a user.

11. The cleaving tool of claim 10, wherein said axis of rotation is set such that only the sharpened blade tip of the fiber engaging member cuts across the optical fiber.

12. The cleaving tool of claim 9, further comprising an adjustable set screw configured to limit a moving distance of the fiber engaging member.

13. The cleaving tool of claim 9, further comprising a blade adjusting screw configured to adjust a position of the fiber engaging member.

14. A cleaving tool for cleaving an optical fiber, comprising:
a cleaving assembly configured to support a connector in a fixed axial position along an axis of an optical fiber extending from an end of the connector, the cleaving assembly including a fiber engaging member having a sharpened blade tip;
a fiber tensioning assembly configured to place an axial tension along the axis of the optical fiber, the fiber tensioning assembly including an actuator member configured to actuate the cleaving assembly and the fiber tensioning assembly; and
means for moving the fiber engaging member along an arcuate path such that the sharpened blade tip cuts across a cut location of the optical fiber by relative movement between the blade tip and the fiber, whereby said axial tension induces crack propagation through the thickness of the fiber at the cut location.
